(19) United States
(12) Patent Application Publication
(10) Pub. No.: US 2012/0279323 A1
(43) Pub. Date: Nov. 8, 2012

(54) INSPECTION DEVICE AND METHOD FOR POSITIONING AN INSPECTION DEVICE

(76) Inventors: Karsten Broda, Gorlitz (DE); Rainer Hofmann, Hemdingen (DE)

(21) Appl. No.: 13/508,606

(22) PCT Filed: Nov. 9, 2010
(86) PCT No.: PCT/EP2010/067114

§ 371 Date: Jul. 13, 2012

(30) Foreign Application Priority Data
Nov. 10, 2009 (EP) 09014043.5

(51) Int. Cl. G01B 5/00

(52) U.S. Cl. 73/865.8

(57) ABSTRACT

An inspection device includes a distal area, a proximal area and a flexible area disposed between the distal area and the proximal area. The flexible area includes a plurality of segments disposed displaceably to each other. At least one external guide element is disposed outside of the flexible area, between the distal area and the proximal area so that the distal area can be displaced with respect to the proximal area with the aid of the external guide element.

### CROSS REFERENCE TO RELATED APPLICATIONS

This application is the US National Stage of International Application No. PCT/EP2010/067114, filed Nov. 9, 2010 and claims the benefit thereof. The International Application claims the benefits of European application No. 09014043.5 EP filed Nov. 10, 2009. All of the applications are incorporated by reference herein in their entirety.

### FIELD OF INVENTION

The present invention relates to an inspection device and a method for positioning an inspection device. In particular, the invention relates to a borescope for use in stationary gas turbines.

### BACKGROUND OF INVENTION

The patent literature has already described a multiplicity of inspection tools, for example endoscopes, bronchoscopes, borescopes and others. However, these inspection tools are frequently designed for a very specific application and, for example, are unsuitable for use in stationary gas turbines. Inspecting annular combustion chambers typically provides particular difficulties as a result of the hub disposed centrally in the annular combustion chamber.

By way of example, GB 2 425 764 B describes an endoscope for inspecting turbines. This inspection tool essentially contains a mechanism that consists of a plurality of individual large and small segments which are interconnected by a Bowden cable. “Tensioning” the Bowden cable pulls the segments together and the latter form a predetermined geometry as a result thereof. Hence the mechanism comprises at least two “states”: one is the slack state, where the individual segments hang loosely from the Bowden cables, and the other state is the tensioned state, where the segments are tensioned with respect to one another and form a predefined geometry. The segments of the moveable part are not completely resting against one another, particularly in the slack state.

The functionality of the inspection tool disclosed in GB 2 425 765 B is almost exclusively defined by the design of the segments. The movement of the segments with respect to one another, for example by a simple, loose link joint, is merely allowed in one movement plane. This loose link joint in each case essentially consists of the “socket” and the associated counterpart, with a segment always having both components in each case, irrespective of its size and length. However, this link joint is only functional for as long as the counterpart of the one segment is mounted in the “socket” of the other segment. If this is not the case, i.e. if the counterpart is not directly in the “socket”, then the desired movement in only one plane in particular, i.e. perpendicular to the rotational axis of the link joint, is no longer possible. As a result of “separation” between individual segments, there may, inter alia, be rotation or torsion of these with respect to one another, as a result of which the aforementioned “end geometry” can no longer be obtained in a reliable and reproducible manner. The frequency of this problem increases with the size and weight of the design of the individual segments.

Without further modifications, the inspection tool described in GB 2 425 764 B is unsuitable for inspecting stationary combustion chambers. This could be shown by a number of practical examinations. In particular, the aforementioned link joint is only able to ensure high positional accuracy to a limited extent because the individual segments are only interconnected by loose link joints. The mutual contact between the segments can be lost at any time whenever the inspection tool is slack. These circumstances act more strongly as the build of the inspection tool, dependent on the region to be inspected, increases. Hence, the accuracy of, for example, a gripper tool that is based on the aforementioned principle and used for minimally invasive surgery is significantly higher. However, the dimensions of such a tool are in a relatively small range between approximately 10 and 50 cm. By contrast, in order to inspect large combustion chambers, as are found in e.g. stationary gas turbines, dimensions of the inspection tool of the order of two to four meters are required. Here, the absolute inaccuracy in the position may lie at a plurality of centimeters.

As a result of the large inaccuracies of the above-described inspection tool as a function of the size thereof, but also as a result of the illustrated problem of torsion as a result of the loose link joint between the individual segments, it is no longer possible to inspect large combustion chambers as are found in e.g. stationary gas turbines.

EP 0 623 004 B1 describes a surgical instrument with an elongate part that serves to be inserted into a body cavity through a restricted opening during use. The elongate part has a plurality of segments that can be moved relative to one another. Here, the relative movement of the segments with respect to one another is restricted by stops.

EP 1 216 796 A1 discloses a gas turbine inspection instrument which comprises two arms that are interconnected with the aid of a joint. The movement of the arms with respect to one another is brought about with the aid of a Bowden cable.

U.S. Pat. No. 2,975,785 describes an optical observation instrument that comprises a flexible region. The flexible region is composed of a number of segments lying against one another, with tensioning cables running through these. The flexible region can be brought into a specific shape with the aid of the tensioning cables.

A further optical observation instrument with a flexible region is disclosed in U.S. Pat. No. 3,270,641. The flexible region comprises a number of segments that are interconnected by joints. The flexible region can be moved with the aid of tensioning cables that run through the joints.

Further endoscopes in which the flexible region is moved with the aid of tensioning cables are described in U.S. Pat. No. 6,793,622 B2, U.S. Pat. No. 5,846,183, U.S. 2004/0193016 A1, U.S. Pat. No. 3,557,780, U.S. Pat. No. 3,109,286, U.S. Pat. No. 3,071,161, U.S. 2002/0193662 A1, JP 2-215436, DE 691 03 935 T2, DE 696 33 320 T2, JP 7-184829, JP 2-257925 and DE 196 08 809 A1.

Further endoscopes are disclosed in DE 198 21 401 A1, EP 1 045 665 B1, JP 03103811 A, DE 103 51 013 A1, DE 690 03 349 T2 and DE 22 37 621.

Moreover, U.S. 2004/0059191 A1 describes a mechanism to move the distal end of an extended inspection tool, for example a borescope. Here, the distal end is moved with the aid of a Bowden cable mechanism.

WO 84/02196 describes an inspection instrument that comprises flexible regions consisting of segments. The flexible regions can be moved by means of wires running within the segments.

U.S. Pat. No. 4,659,195 discloses a borescope with a flexible region that has an integral design. The flexible region can be bent into various directions with the aid of four control cables.

DE 43 05 376 C1 discloses a shaft for medical instruments, which discloses segments that are connected in an articulated manner or by force-fit using tensioning wires. Various curvatures of the shaft can be set with the aid of control wires that pass through the segments.

DE 34 05 514 A1 describes a technoscope that comprises a distal flexible region. The distal flexible region can be deflected without restrictions using control wires lying therein. Moreover, the distal flexible region may have segments that are interconnected in an articulated manner.

### SUMMARY OF INVENTION

Against this backdrop, it is a first object of the present invention to make available an advantageous inspection device. A second object consists of making available an advantageous method for positioning an inspection device in a cavity.

The above objects are achieved by the features of the independent claims. The dependent claims contain further, advantageous embodiments of the invention.

The inspection device according to the invention comprises a distal region, a proximal region and a flexible region disposed between the distal region and the proximal region. The flexible region comprises a number of segments that are moveably disposed with respect to one another. At least one external guide element is disposed outside of the flexible region between the distal region and the proximal region such that the distal region can be moved with respect to the proximal region with the aid of the external guide element. The external guide element affords targeted maneuvering of the flexible region, particularly in narrow cavities. This also allows regions that are difficult to access to be reached with the aid of the inspection device according to the invention.

The external guide element can advantageously be embodied as a cable, more particularly as a wire cable, or as a chain.

Furthermore, the distal region can be equipped with a sensor, for example with an inspection camera.

The external guide element can be attached to the distal region and/or to the proximal region. The external guide element is, with a first end, preferably attached to the distal region, and a second end of the external guide element is loosely connected to the proximal region such that the external guide element can be operated, i.e. tensioned or loosened for example, from the proximal region.

Furthermore, the distal region and/or the proximal region can comprise a number of segments that are moveably disposed with respect to one another. These segments may be the same segments that also make up the flexible region. The external guide element, for example the wire cable, may advantageously be attached to the outer segment of the distal region. Moreover, the second end of the external guide element can be connected to a segment of the proximal region or can pass through openings in the segment. Here, the connection can be embodied such that the external guide element can be used to set the distance between the distal region and the proximal region.

Moreover, the segments can be interconnected with the aid of at least one internal cable, for example a Bowden cable. Here, the segments of the flexible region can be connected amongst themselves, and the segments of the flexible region can also be connected to the segments of the distal region and/or to the segments of the proximal region. The internal cable is advantageously a wire cable. The inspection device preferably comprises two internal wire cables. In this case, the two wire cables may be interconnected to form one cable in the distal region.

The internal cable or the internal cables can be routed through the segments through bores in the segments. By way of example, the segments can be embodied in the form of hollow cylinders. In this case, the cable or the cables can run parallel to an imagined longitudinal axis of the respective segment. In the case of two cables, these can preferably be disposed opposite one another with respect to the longitudinal axis of the segment. The segments are preferably interconnected at the respective base and cover faces or rest against one another at the respective base and cover faces.

Moreover, at least one segment can have the shape of a hollow cylinder with a number of openings in the lateral face of the hollow cylinder. As a result of such an embodiment of the segments, it is possible to significantly reduce the weight of the inspection device without this being to the detriment of the stability of the inspection device.

Furthermore, the segments can have an angled base face and/or an angled cover face with respect to an imagined longitudinal axis of the segment. The shape of the segments, more particularly the angles between the longitudinal axis and the base face or cover face of the respective segment, in conjunction with the specific arrangement of the segments predetermines the geometry that can be set with the aid of the flexible region.

Additionally, at least two of the aforementioned segments, preferably all segments, can be interconnected in an articulated and/or interlocking fashion.

By way of example, the inspection device can be embodied as a borescope, more particularly as a borescope for inspecting annular combustion chambers. By way of example, the borescope can consist of a titanium alloy or comprise a titanium alloy.

If the device according to the invention is applied within the scope of examining a combustion chamber, the distal region, the flexible region and at least part of the proximal region can be inserted into the combustion chamber through a flange for a flame detector.

The method according to the invention for positioning an inspection device in a cavity relates to an inspection device that comprises a distal region, a proximal region, a flexible region disposed between the distal region and the proximal region, and at least one external guide element. Here, the external guide element is disposed outside of the flexible region between the distal region and the proximal region. Within the scope of the method according to the invention, the distal region is moved with respect to the proximal region with the aid of the external guide element.

The method according to the invention can more particularly be carried out with the aid of the inspection device according to the invention. By way of example, the distal region can comprise a sensor, e.g. a video camera.

An external cable, for example a wire cable, or a chain can advantageously be used as external guide element.

Moreover, the flexible region can comprise a number of segments that are moveably disposed with respect to one another. Here, the segments can be interconnected with the aid of at least one internal cable. The distal region and the flexible region can advantageously be inserted into a cavity, e.g. an annular combustion chamber, through an opening. The internal cable is in a slack state during insertion, i.e. the segments can move relative to one another. In doing so, the distal region can be led to the proximal region with the aid of the external guide element. The internal cable can subsequently be tensioned. As a result thereof, the distal region can be moved away from the proximal region. If the external guide element is embodied as an external cable, this external cable can be tensioned when the distal region is led to the proximal region. The external cable can subsequently slacken while the distal region is moved away from the proximal region. In particular, the flexible region can form a loop while the distal region is led to the proximal region.

By way of example, the distal region and the flexible region can be introduced into a component of a gas turbine, e.g. a combustion chamber, through an opening. The combustion chamber can, in particular, comprise a hub. When the distal region and the flexible region are inserted, these regions can be routed past the hub. In particular, this may be achieved by virtue of the fact that the distal region is initially led to the proximal region with the aid of the external guide element, more particularly the external wire cable, with the flexible region assuming the shape of a loop. The distal region is subsequently moved away from the proximal region by tensioning the internal cable, and guided to the region of the combustion chamber to be examined The combustion chamber can more particularly be an annular combustion chamber.

The method according to the invention enables targeted maneuvering of long inspection devices in particular, e.g. borescopes, in spaces that are difficult to access, such as e g annular combustion chambers with a hub.

With the aid of the inspection device according to the invention and the method according to the invention it is possible, in a quick and effective manner, to examine combustion chambers of gas turbines in particular in respect of possible faults. Since the inspection device according to the invention and the method according to the invention also afford the possibility of quickly and easily accessing and examining regions within the interior of the combustion chamber that are usually difficult to access, this significantly reduces the inspection time and hence the time that the gas turbine stands still. At the same time, this increases the availability and flexibility of the gas turbine or combustion chamber. In particular, it is quick and easy to find attacked or destroyed ceramic heat shields with the aid of the inspection device according to the invention and the method according to the invention.

### BRIEF DESCRIPTION OF THE DRAWINGS

Further advantages, properties and features of the present invention will be explained in more detail below on the basis of an exemplary embodiment, with making reference to the attached figures. Here, the described features are advantageous both on their own and in combination.

FIG. 1 schematically shows a borescope according to the invention.

FIG. 2 schematically shows a connection between two segments according to the prior art from GB 2 425 764 B.

FIG. 3 schematically shows the tip of the borescope which has been equipped with a video camera.

FIG. 4 schematically shows an example of the functionality of the flexible region of the borescope.

FIG. 5 schematically shows an example of a borescope for examining the upper region of a combustion chamber.

FIG. 6 schematically shows an example of a borescope for examining the lower region of a combustion chamber.

FIG. 7 schematically shows the borescope inserted into the combustion chamber, with a tensioned external wire cable.

FIG. 8 schematically shows the borescope inserted into the combustion chamber, with tensioned internal wire cables and a slack external wire cable.

FIG. 9 shows a longitudinal partial section of a gas turbine in an exemplary manner

FIG. 10 shows a gas turbine combustion chamber.

### DETAILED DESCRIPTION OF INVENTION

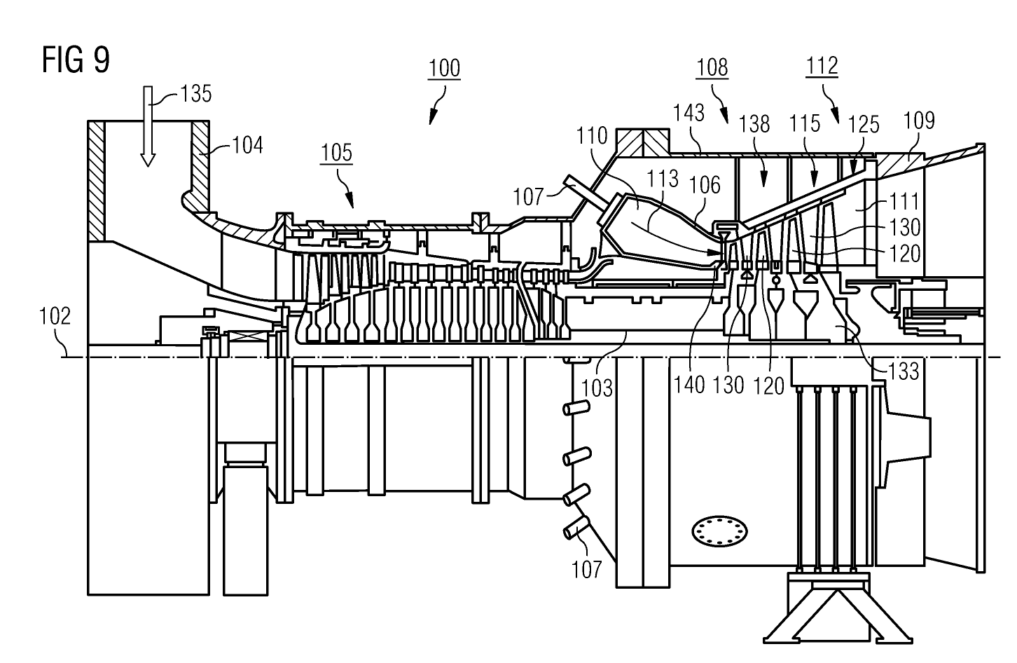

FIG. 9 shows a longitudinal partial section of a gas turbine 100 in an exemplary manner

In the interior, the gas turbine 100 has a rotor 103 with a shaft 101, which rotor is rotatably mounted around a rotational axis 102 and also referred to as turbine rotor.

An intake housing 104, a compressor 105, an e.g. toroidal combustion chamber 110, more particularly an annular combustion chamber, with a plurality of coaxially disposed burners 107, a turbine 108 and the exhaust-gas housing 109 successively follow one another along the rotor 103.

The annular combustion chamber 110 is in communication with an e g annular hot-gas duct 111. There, e.g. four turbine stages 112 connected in series form the turbine 108.

By way of example, each turbine stage 112 is made of two blade or vane rings. As seen in the flow direction of a work medium 113, a row 125 made of rotor blades 120 follows a guide-vane row 115 in the hot-gas duct 111.

Here, the guide vanes 130 are attached to an inner housing 138 of a stator 143, whereas the rotor blades 120 of one row 125 are for example attached to the rotor 103 by means of a turbine disk 133.

A generator or a machine (not illustrated) is coupled to the rotor 103.

During the operation of the gas turbine 100, air 135 is suctioned through the intake housing 104 and compressed by the compressor 105. The compressed air provided at the turbine-side end of the compressor 105 is routed to the burners 107 and there it is mixed with fuel. The mixture is then combusted in the combustion chamber 110 so as to form the work medium 113. From there, the work medium 113 flows along the hot-gas duct 111, past the guide vanes 130 and the rotor blades 120. The work medium 113 relaxes at the rotor blades 120, transmitting momentum in the process, and so the rotor blades 120 drive the rotor 103, and the latter drives the machine coupled thereto.

The components exposed to the hot work medium 113 are subject to thermal loading during the operation of the gas turbine 100. In addition to the heat shield elements covering the annular combustion chamber 110, the guide vanes 130 and the rotor blades 120 of the first turbine stage 112 as seen in the flow direction of the work medium 113 are subjected to the greatest thermal loads.

In order to withstand the temperatures that prevail there, these can be cooled by means of a coolant. Substrates of the components can likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blades or vanes 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B 1, EP 0 786 017 B1, EP 0 412 397 B1 or EP 1 306 454 A1.

It is also possible for a thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

The guide vane 130 has a guide vane root (not illustrated here), which faces the inner housing 138 of the turbine 108, and a guide vane head which is at the opposite end from the guide vane root. The guide vane head faces the rotor 103 and is fixed to an attachment ring 140 of the stator 143.

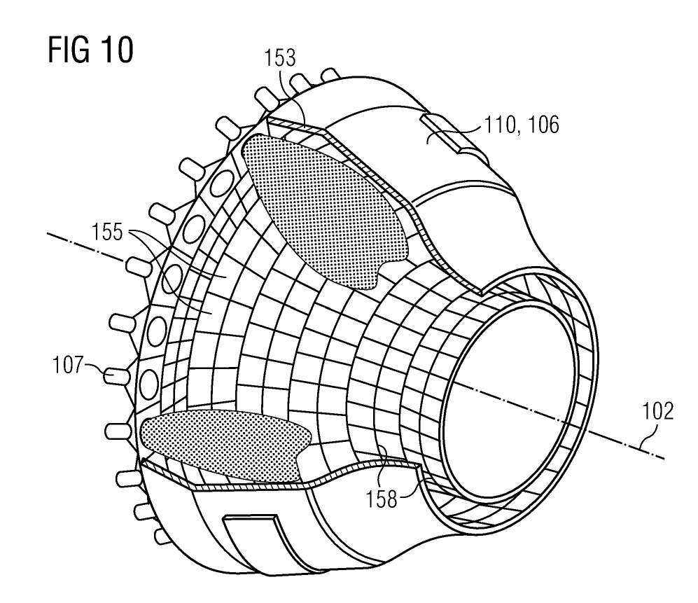

FIG. 10 shows a combustion chamber 110 of a gas turbine. By way of example, the combustion chamber 110 is embodied as a so-called annular combustion chamber, in which a multiplicity of burners 107, which are disposed around a rotational axis 102 in the circumferential direction, open into a common combustion-chamber space 154 and produce the flames 156. To this end, the combustion chamber 110 in its entirety is embodied as an annular structure, which is positioned around the rotational axis 102.

So as obtain comparatively high efficiency, the combustion chamber 110 is designed for a comparatively high temperature of the work medium M of approximately 1000° C. to 1600° C. So as to enable a comparatively long period of operation, even at these operational parameters that are inexpedient for the materials, the combustion chamber wall 153 has, on its side facing the work medium M, been provided with an inner cover formed from heat shield elements 155.

Each heat shield element 155 made of an alloy is equipped with a particularly heat-resistant protective layer (MCrAlX-layer and/or ceramic coating) on the work-medium side or made of a high-temperature resistant material (massive ceramic stones).

These protective layers may be similar to the turbine blades or vanes, i.e. this means e.g. MCrAlX: M is at least one element selected from the group consisting of iron (Fe), cobalt (Co), nickel (Ni), X is an active element and stands for yttrium (Y) and/or silicon and/or at least one rare earth element, or hafnium (Hf). Alloys of this type are known from EP 0 486 489 B1, EP 0 786 017 B1, EP 0 412 397 B1 or EP 1 306 454 A1.

It is also possible for an e.g. ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating methods are feasible, e.g. atmospheric plasma spraying (APS), LPPS, VPS or CVD. The thermal barrier coating may include grains that are porous or have micro-cracks or macro-cracks, in order to improve the thermal shock resistance.

Refurbishment means that after they have been used, heat shield elements 155 may have to be freed from protective layers (e.g. by sand-blasting). Then, the corrosion and/or oxidation layers and products are removed. If need be, cracks in the heat shield element 155 are also repaired. This is followed by recoating of the heat shield elements 155, after which the heat shield elements 155 are reused.

A cooling system may moreover be provided for the heat shield elements 155, or the holding elements thereof, as a result of the high temperatures in the interior of the combustion chamber 110. By way of example, the heat shield elements 155 are then hollow and optionally have cooling holes (not illustrated) that open out into the combustion-chamber space 154.

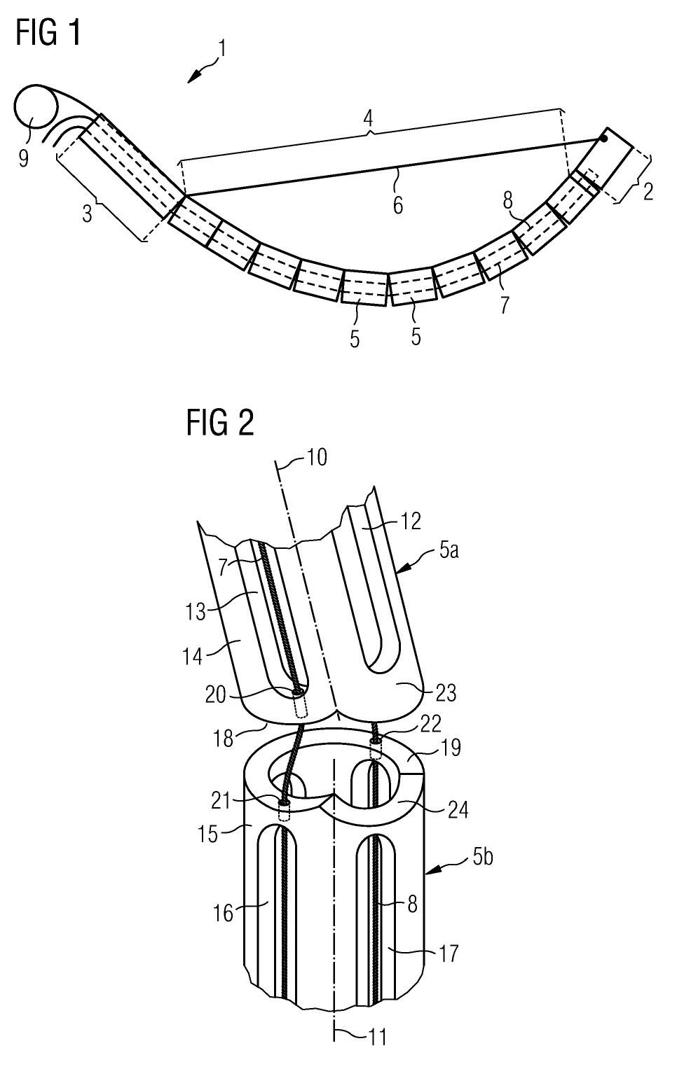

In the following text, the inspection device according to the invention and the method according to the invention are explained in more detail using FIGS. 1 to 8. FIG. 1 schematically shows an inspection device according to the invention, which is embodied as a borescope 1. The borescope 1 comprises a distal region 2, a flexible region 4 and a proximal region 3. The flexible region 4 is disposed between the proximal region 3 and the distal region 2. The flexible region 4 comprises a number of segments 5. The distal region 2 and/or the proximal region 3 can likewise comprise a number of segments. The segments 5 are interconnected with the aid of wire cables 7 and 8 that are disposed in the interior of the segments 5. The wire cables 7 and 8 may also merely be one wire cable, which firstly passes through the segments 5 from the proximal region 3 to the distal region 2, then is deflected in the distal region 2 and subsequently is routed back through the segments 5 to the proximal region 3.

The segments 5 can have the shape of hollow cylinders, wherein the base face and/or the cover face may have an angled design with respect to an imagined longitudinal axis of the segment. The internal wire cables 7, 8 are preferably disposed in the wall region of the respective hollow cylinders and run parallel to the longitudinal axis of the respective hollow cylinders. A probe, e.g. a video camera, can be passed through the central opening of the hollow cylinder from the proximal region 3 to the distal region 2.

The distal region 2 is connected to the proximal region 3 via an external wire cable 6. A chain can also be used instead of the wire cable 6. The external wire cable 6 runs outside of the segments 5 of the flexible region 4. The first end of the external wire cable 6 is preferably attached to the distal region 2, more particularly to the outermost segment of the distal region 2. The second end of the external wire cable 6 is preferably routed along the interior of the proximal region 3 and wound onto a winch 9. The winch 9 can be used to pull or tension, or loosen the external wire cable 6 according to requirements.

The internal wire cables 7, 8 can likewise be in a slack state or a tensioned state. If the internal wire cables 7, 8 are in a slack state, the segments 5 of the flexible region 4 hang loosely next to one another. If the internal wire cables 7, 8 are tightened, the flexible region 4 forms a predetermined geometry, depending on shape, arrangement and size of the segments 5.

By way of example, the borescope can consist of a titanium alloy or comprise a titanium alloy.

FIG. 2 schematically shows the connection between two segments of a borescope as per the prior art from GB 2 425 764 B. FIG. 2 shows two segments 5a and 5b, which each have a hollow cylinder as basic shape. The longitudinal axis of the segment 5a is denoted by reference sign 10. The longitudinal axis of segment 5b is denoted by reference sign 11. The lateral face of segment 5a is denoted by reference sign 14 and the lateral face of segment 5b is denoted by reference sign 15. Segment 5a has a number of openings 12, 13 in the region of the lateral face 14. Similarly, the lateral face 15 comprises openings 16, 17.

The base face 18 of segment 5a points in the direction of the cover face 19 of the segment 5b. There is a bore 20 in the base face 18 of the segment 5a and it runs from the base face 18 to the opening 13. With respect to the longitudinal axis 10, there is an analogous bore in the base face 18 on the opposite side of the bore 20. Correspondingly, there are, with respect to the longitudinal axis 11, oppositely disposed bores 21 and 22 in the cover face 19 of the segment 5b, with these bores respectively running from the cover face 19 to the respective opening 16 or the opening lying opposite thereto. A wire cable 7 is threaded through the bores 20 and 21, and the segments 5a and 5b are interconnected thereby. Analogously, a further wire cable 8 is pulled through the bore 20 and the bore in the segment 5a corresponding thereto.

The segment 5a comprises a joint head 23 in the region of its base face 18. The segment 5b comprises a socket 24 in the region of its cover face 19. The socket 24 is disposed such that the joint head 23 engages into the socket 24 when the wire cables 7 and 8 are tensioned.

FIG. 2 shows that there is no contact between the segments 5a and 5b if the wire cables 7 and 8 are slack, e.g. when the borescope is inserted, and, as a result, no functionality of the joint link is established in this case either. The movement of the segments 5a and 5b with respect to one another is not restricted in any way in this case, as a result of which there is great inaccuracy when positioning the borescope.

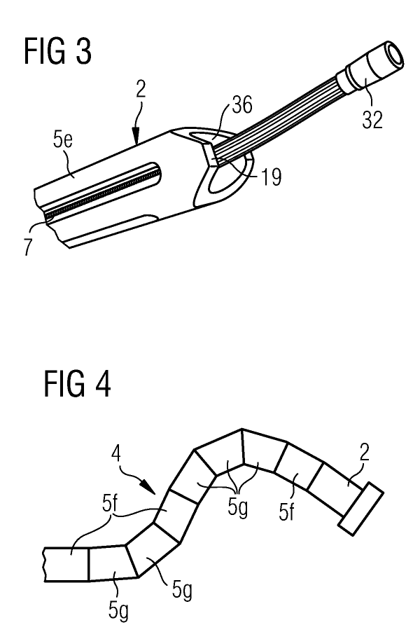

FIG. 3 schematically shows the distal region 2 of the borescope 1, or the tip of the borescope 1. The distal region 2 of the borescope 1 consists of one segment 5e.

The segment 5e is shaped like a hollow cylinder with a pointed cover face 19 and a lateral face 37. The lateral face 37 comprises openings 31 that extend along an imagined longitudinal axis 39 of the segment 5e.

The segment 5e differs from the above-described segments by virtue of the fact that the internal wire cables 7 and 8 are fixedly connected to the segment 5e. By way of example, the internal wire cables 7 and 8 can be fixedly anchored in the bores 30 situated in the cover face 19. A sensor 32, which may be e.g. a video camera, is pushed through the channel-shaped opening 36 disposed along the longitudinal axis of the segment 5e, or through the corresponding cavity 36. By way of example, this sensor 32 can be used to examine the interior of a combustion chamber.

FIG. 4 schematically shows an example of the functionality of the flexible region 4 of the borescope 1 and an example of an embodiment of the flexible region 4. The flexible region 4 adjoining the distal region 2 comprises a number of segments 5f and 5g. Segments 5f and 5g, respectively disposed next to one another, are interconnected.

The segments 5f have a hollow-cylindrical shape, with base face and cover face running parallel to one another. The segments 5g likewise have a hollow cylindrical shape, with, however, the base face and/or the cover face being angled in respect of the longitudinal axis of the respective hollow cylinder. An appropriate sequence of segments 5f and segments 5g obtains a predetermined geometry in the tensioned state of the

Bowden cables 7 and 8 of the borescope 1. In particular, the borescope 1 can, in the tensioned state, i.e. when the internal cable wires 7 and 8 are tensioned, have specific curvatures. This makes it possible to examine regions of e.g. a combustion chamber that are difficult to access.

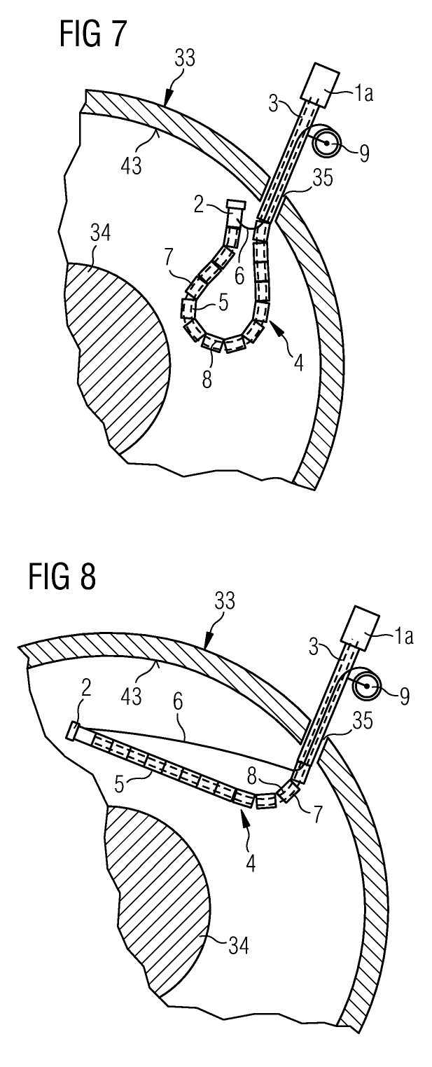

FIG. 5 shows a borescope 1a according to the invention, which is suitable for examining the upper region of a combustion chamber. FIG. 7 shows a section through a combustion chamber 30 perpendicular to the central axis 41 of the combustion chamber 33. The combustion chamber 33 comprises a hub 34 disposed in the region of the central axis 41. The combustion chamber 33 is an annular combustion chamber. The combustion chamber 33 comprises an outer wall 42, in which a flange 35 for a flame detector is situated. The outer wall 42 of the annular combustion chamber 33 moreover comprises an upper inner face 43 and a lower inner face 44.

The distal region 2 and the flexible region 4, and also part of the proximal region 3 of the borescope 1a have been inserted into the interior of the annular combustion chamber 33 through the outer wall 42 through the flange 35. Within the scope of the flexible region 4, a number of segments 5g with angled base face and/or angled cover face first of all adjoin the proximal region 3. In the direction of the distal region 2, the segments 5g are adjoined by further segments 5f, in which the base face and the cover face run parallel to one another.

FIG. 5 illustrates the borescope 1a in the case of tensioned internal wire cables 7 and 8. The arrangement of the segments 5g and 5f means that the borescope 1a assumes a V-shape in the tensioned state. The distal region 2, in which e.g. a video camera is situated, in this case points upward to the upper inner face 43 of the combustion chamber 33.

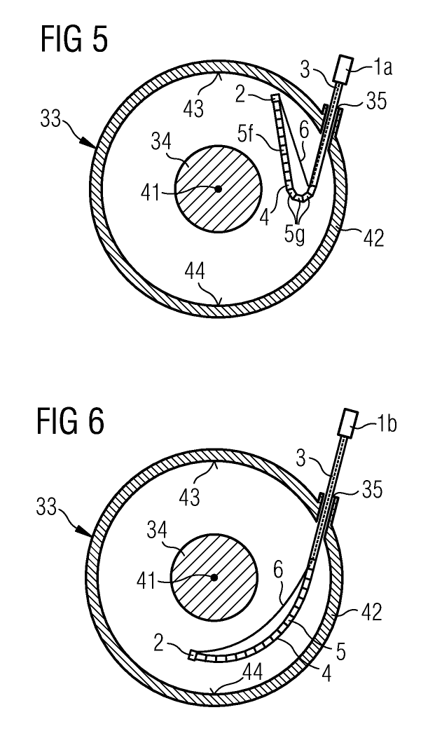

FIG. 6 schematically shows a borescope 1b according to the invention, which is suitable for inspecting the lower region of the combustion chamber 33 and has been inserted into the annular combustion chamber 33 already described in conjunction with FIG. 5. The distal region 2 and the flexible region 4, and also part of the proximal region 3 have been inserted into the interior of the combustion chamber 33 through the flange 35. The segments 5 of the flexible region 4 are embodied such that the flexible region is disposed in an arc-shaped manner around the hub 34 in the tensioned state of the Bowden cables 7, 8. Here, the distal region 2, and the video camera disposed in this region or a sensor disposed in this region, are situated in the region of the lower inner face 44 of the annular combustion chamber 33. The arrangement shown in FIG. 8 can be used to examine the lower region of the combustion chamber 33, more particularly the lower inner face 44.

The following text will explain the insertion of a borescope 1a, suitable in particular for examining the upper region of a combustion chamber 33, into the combustion chamber 33 in more detail on the basis of FIGS. 7 and 8. FIGS. 7 and 8 show the annular combustion chamber 33, already described in conjunction with FIGS. 5 and 6, with the hub 34 disposed in the interior thereof.

In a first step, initially the distal region 2 and subsequently the flexible region 4 are successively inserted through the flange 35 into the interior of the combustion chamber. In doing so, the external wire cable 6 is successively tensioned as soon as the distal region 2 and approximately half of the length of the flexible region 4 are inserted into the interior of the combustion chamber 33. After the flexible region 4 has been completely inserted into the combustion chamber 33 and the external wire cable 6 has been completely tensioned, the borescope 1a has the shape of a loop shown in FIG. 7. The internal wire cables 7 and 8 are loosened while the distal region 2 and the flexible region 4 are inserted, and so the segments 5 can move freely with respect to one another.

In a second step, the external wire cable 6 is slowly loosened, while the internal wire cables 7 and 8 are slowly pulled or tightened. In the process, the base faces and cover faces of the respectively adjoining segments 5 are tightly pulled against one another and the geometry of the flexible region 4 of the borescope 1a, which is predetermined by the shape of the segments 5, sets in. At the end of this process, the external wire cable 6 is slack and the internal wire cables 7 and 8 are completely pulled, i.e. in a tensioned state. The result is shown in FIG. 8. The distal region 2 of the borescope 1a now points in the direction of the upper inner face 43 of the combustion chamber 33.

The external wire cable 6 can be operated, i.e. wound and unwound again, with the aid of a winch 9 disposed outside of the combustion chamber 33. In FIG. 7, the external wire cable 6 is completely wound onto the winch 9. In FIG. 8, the external wire cable 6 is almost completely unwound from the winch 9.

With the aid of the above-described method, the distal region 2 of the borescope 1a can be guided past the hub 34 in an elegant manner. Without the described application of the external wire cable 6, the borescope 1a could only examine the lower region or the lower inner face 44 of the combustion chamber 33.

1-8. (canceled)

9. An inspection device, comprising:
a distal region,
a proximal region, and
a flexible region disposed between the distal region and the proximal region,
wherein the flexible region comprises a plurality of segments that are moveably disposed with respect to one another,
wherein at least one external guide element is disposed outside of the flexible region between the distal region and the proximal region such that the distal region is movable with respect to the proximal region with the aid of the external guide element,
wherein the external guide element is attached to the distal region and/or to the proximal region, and
wherein the distal region and/or the proximal region comprise(s) a plurality of segments that are moveably disposed with respect to one another.

10. The inspection device as claimed in claim 9, wherein the external guide element is embodied as a cable or as a chain.

11. The inspection device as claimed in claim 9, wherein the segments are interconnected with the aid of at least one internal cable.

12. The inspection device as claimed in claim 9, wherein at least one of the segments has the shape of a hollow cylinder with a number of openings in the lateral face of the hollow cylinder.

13. The inspection device as claimed in claim 9, wherein at least two of the segments are interconnected in an articulated and/or interlocking fashion.

14. The inspection device as claimed in claim 9, wherein the inspection device is embodied as a borescope.

15. A method for positioning an inspection device in a cavity, the inspection device comprising a distal region, a proximal region, a flexible region disposed between the distal region and the proximal region, and at least one external guide element, with the external guide element being disposed outside of the flexible region between the distal region and the proximal region, the method comprising:
moving the distal region is with respect to the proximal region with the aid of the external guide element.

16. The method as claimed in claim 15, wherein the flexible region comprises a plurality of segments that are moveably disposed with respect to one another, the segments being interconnected with the aid of at least one internal cable, wherein the method further comprises:
inserting the distal region and the flexible region into a cavity through an opening, with the internal cable being in a slack state,
leading the distal region to the proximal region with the aid of the external guide element,
tensioning the internal cable to resultantly move the distal region away from the proximal region.
